(19) United States
(12) Patent Application Publication
(10) Pub. No.: US 2006/0215024 A1
(43) Pub. Date: Sep. 28, 2006

(54) Method and real time emergency response surveillances system with an emergency switch

(76) Inventors: Charles Kevin Coonce, Parma, MI (US); Mark James Maloney, Jackson, MI (US)

Correspondence Address: ICE MILLER LLP, ONE AMERICAN SQUARE, SUITE 3100, INDIANAPOLIS, IN, 46282-0200, US

(21) Appl. No.: 11/088,162

(22) Filed: Mar. 23, 2005

(51) Int. Cl. H04N 7/18; H04N 9/47

(52) U.S. Cl. 348/143

(57) ABSTRACT

A real time emergency response surveillance system, method and computer readable medium storing a computer program for responding to an emergency situation are disclosed. The system includes one or more surveillance stations communicatively coupled to an operations center. Each surveillance station includes a controller, a video camera, a communication module, a display screen and an emergency switch. The surveillance station can be placed in one of a surveillance mode and an emergency response mode. The surveillance station can be placed in emergency response mode responsive to an emergency signal received from the operations center or responsive to activation of the emergency switch. Real time video data is transmitted from the surveillance station to the operations center in both the surveillance mode and the emergency response mode. Real time video data is received from the operations center at the surveillance station in emergency response mode. The real time video received at the surveillance station is displayed on the display screen in the emergency response mode.

### FIELD OF THE INVENTION

The present invention relates generally to a surveillance system. In particular, the invention relates to a method and system for providing a surveillance station with an emergency switch where a real time two way audio/video communication channel is established between the surveillance station and an operations center upon activation of the emergency switch.

### BACKGROUND OF THE INVENTION

Emergency situations often require the immediate implementation of appropriate emergency procedures to minimize injuries and loss of human life. For example, in the event of a building emergency, such as for example a fire, providing immediate effective professional guidance to the building occupants during a building evacuation may save lives. Also in the event of large scale emergencies, such as for example, a hurricane, an earthquake or tornado, providing prompt warnings and guidance via direct communication with the people in the vicinity of the emergency situation may be instrumental in minimizing panic and guiding people in the vicinity of the emergency situation to locations of greater safety.

Public areas are sometimes placed under surveillance and monitored by live personnel at remote monitoring centers. However, in the event of an emergency, personnel at the monitoring centers do not typically provide themselves provide guidance to the people in the vicinity of the emergency situation. Such monitoring centers may contact an emergency response facility, such as for example, the police department or fire department to respond to the emergency situation.

Strategically placed emergency telephones may be available to a user to request emergency assistance in the event of an emergency situation. However, the locations of such telephones may not be readily known to customers, guests or other visitors present at the facility. In addition, the verbal information that might be conveyed to and from the user in an emergency is limited to the communication skills of the user and the recipient at the other end of the phone line and the audio quality of their communications. Visitors such as tourists may not speak the same language as the emergency personnel. In emergencies, environment noise and potential hearing loss present in or suffered by the user in the emergency may greatly impede the flow of useful information.

In addition, and depending on the severity of the emergency, the user of one-way real-time surveillance systems described above may not be able to speak or communicate with enough clarity to provide the needed information to the emergency monitoring personnel. Smoke and other conditions may impair the unprotected user's breathing due contamination of the ambient air at the emergency site, thus inhibiting or foreclosing meaningful oral communications from the emergency user's location.

In order to overcome some of these potential disadvantages, others have suggested surveillance systems involving audio communication and one-way real-time video surveillance whereby an emergency monitoring person can view conditions at the location of the emergency user. See, e.g. U.S. Patent Application Publication No. US 2003/0227540 and U.S. Pat. No. 6,538,689. While these types of one-way real-time video surveillance systems may provide some useful visual information to the emergency personnel, the persons present at the emergency site must rely on the quality of the communication from the emergency personnel. Such limitations prevent, for example, display of location maps, exits, and best exit route(s) to the user. In addition, if the user does not share a common language with the emergency personnel the former's requests and the latter's instructions may be meaningless.

Some emergency situations may require access to medical or other emergency equipment or supplies at the site of the emergency. If such materials can be provided in the system and properly used, lives may be saved. However, improper access and/or incorrect use of such material by untrained persons is wasteful and may not be helpful in improving the emergency situation. Controlled access and dispensation of the appropriate materials in the appropriate circumstances would be beneficial. To date, however, surveillance systems do not appear to provide such controlled access and dispensation and real-time communication of audio and video instructions to the user at the site of the emergency.

It is desirable, therefore, to provide systems and methods for responding to an emergency situation that overcomes one or more of the prior art limitations described above.

### SUMMARY OF THE INVENTION

One aspect of the present invention provides a surveillance station including a controller communicatively coupled to a video camera, a communication module, a display screen and an emergency switch. The controller is operable to place the surveillance station in one of a surveillance mode and an emergency response mode. The communication module is operable to transmit real time video data from the video camera to an operations center in both the surveillance mode and the emergency response mode and to receive real time video data from the operations center in the emergency response mode. The display screen is operable to display the real time video data received from the operations center. The controller is operable to place the surveillance station in the emergency response mode responsive to activation of the emergency switch.

Another aspect of the invention provides a method of monitoring a site using a surveillance station. The method includes placing a surveillance station in one of a surveillance mode and an emergency response mode, transmitting real time video data from the surveillance station to an operations center in both the surveillance mode and the emergency response mode, receiving real time video data from the operations center at the surveillance station in the emergency response mode, displaying the real time video data received from the operations center on a display screen at the surveillance station, and placing the surveillance station in emergency response mode responsive to activation of an emergency switch.

Another aspect of the invention provides a computer readable medium for storing a computer program for monitoring a site using a surveillance station. The computer program includes computer readable code for placing a surveillance station in one of a surveillance mode and an emergency response mode, computer readable code for transmitting real time video data from the surveillance station to an operations center in both the surveillance mode and the emergency response mode, computer readable code for receiving real time video data from the operations center at the surveillance station in emergency response mode, computer readable code for displaying the real time video data received from the operations center on a display screen in emergency response mode, and computer readable code for placing the surveillance station in the emergency response mode responsive to activation of an emergency switch.

Another aspect of the invention provides a real time emergency response surveillance system. The system includes a plurality of surveillance stations, each of the plurality of surveillance stations having an emergency switch and being operable to be individually placed in one of an emergency response mode and a surveillance mode, wherein each of the surveillance stations is operable to be individually placed in emergency response mode responsive to activation of the emergency switch, and an operations center communicatively coupled to the plurality of surveillance stations, wherein a first of the plurality of surveillance stations is operable to transmit real time video data from the first surveillance station to the operations center in both the surveillance mode and the emergency response mode, and wherein the first surveillance station is operable to receive real time video data from the operations center in emergency response mode.

Optionally, the foregoing systems, methods and software may permit the operation center to release medical or other emergency equipment or supplies locked in the station.

### BRIEF DESCRIPTION OF THE DRAWINGS

The present invention is illustrated by way of example and not limited in scope to the accompanying figures, in which like references indicate similar elements, and in which:

FIG. 1 is a schematic block diagram of an embodiment of a real time emergency response surveillance system in accordance with the principles of the present invention;

FIG. 2 is a schematic block diagram of an embodiment of a surveillance station in accordance with the principles of the present invention;

FIG. 3 is a schematic block diagram of an embodiment of an operations center in accordance with the principles of the present invention

FIG. 4 is an illustration of an embodiment of the surveillance station in accordance with the principles of the present invention;

FIG. 5 a-c is a flowchart of one embodiment of a method of operating the surveillance station in emergency response mode where the surveillance station has been placed in emergency response mode responsive to activation of an emergency switch in accordance with the principles of the present invention; and

FIG. 6 a-b is a flowchart of one embodiment of a method of operating the surveillance station in emergency response mode where the surveillance station has been placed in emergency response mode by the operations center in accordance with the principles of the present invention.

### DETAILED DESCRIPTION OF THE PREFERRED EMBODIMENTS

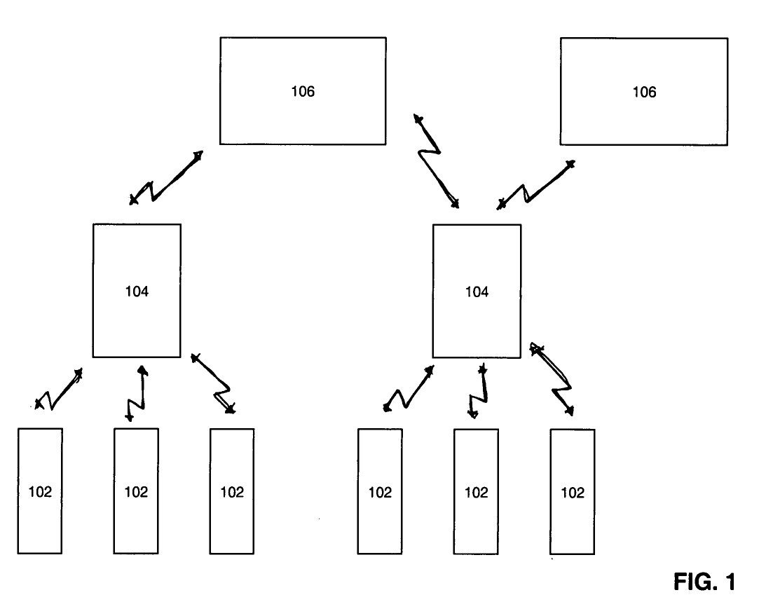

FIG. 1 is a schematic diagram of one embodiment of a real time emergency response surveillance system 100, in accordance with the principles of the present invention. The real time emergency response surveillance system 100 includes one or more standalone surveillance stations 102 and one or more operations centers 104. Each operations center 104 is communicatively coupled to one or more surveillance stations 102. In one embodiment, one or more of the operations centers 104 are communicatively coupled to an emergency response center 106.

In one embodiment, each surveillance station 102 is configured to transmit and receive audio and video data to and from an operations center 104 via communication networks that enable high speed audio and video communication. Examples of such communication systems include, but are not limited to, T1 line, T3 line, OC3 fiber, OC12 fiber, OC48 fiber, OC192 fiber, digital subscriber line (DSL) or any other high speed communication lines that may be apparent to one having ordinary skill in the art. A combination of wired and wireless communications networks may also be employed without departing from the spirit of the invention.

In another embodiment each surveillance station 102 is configured to transmit and receive audio data and video data to and from an operations center 104 via a satellite communication network. The surveillance station 102 may be communicatively coupled to a router via a wired communication link, a wireless communication link or a combination wired and wireless communication link. The router may be communicatively coupled to the satellite dish via a wired communication link, a wireless communication link or a combination wired and wireless communication link. The operations center 104 may include one or more operations center advisor stations. Each operations center advisor station may be communicatively coupled to the router via a wired communication link, a wireless communication link or a combination wired and wireless communication link. The router may be communicatively coupled to the satellite dish via a wired communication link, a wireless communication link or a combination wired and wireless communication link.

In one embodiment, one or more of the operations centers 104 are communicatively coupled to one or more emergency response centers 106. Each operations center 104 is configured to receive audio and video data from an emergency response center 106 via communication networks that enable high speed audio and video communication. Examples of such communication systems include, but are not limited to, T1 line, T3 line, OC3 fiber, OC12 fiber, OC48 fiber, OC192 fiber, digital subscriber line (DSL) or any other high speed communication lines that may be apparent to one having ordinary skill in the art. A combination of wired and wireless communications networks may also be employed without departing from the spirit of the invention.

In another embodiment one or more of the operations centers 104 are configured to receive audio data and video data from one or more emergency response centers 106 via a satellite communication network. The operations center 104 may be communicatively coupled to a router via a wired communication link, a wireless communication link or a combination wired and wireless communication link. The router may be communicatively coupled to the satellite dish via a wired communication link, a wireless communication link or a combination wired and wireless communication link. The emergency response center 106 may be communicatively coupled to the router via a wired communication link, a wireless communication link or a combination wired and wireless communication link. The router may be communicatively coupled to the satellite dish via a wired communication link, a wireless communication link or a combination wired and wireless communication link.

In one presently preferred embodiment, each of the surveillance stations 102 can be placed in one of two operating modes: a surveillance mode and an emergency response mode. The surveillance mode is the default surveillance station 102 operating mode. In one embodiment, when a surveillance station 102 is in surveillance mode, surveillance video cameras and microphones are active and real time audio/video data is continuously transmitted from the surveillance station 102 to the operations center 104 for real time evaluation by one or more operations center advisors. In another embodiment, the surveillance video camera is active and real time video is transmitted from the surveillance station 102 to the operations center 104 in surveillance mode. The operations center 104 is preferably staffed with one or more operations center advisors around the clock. The operations center advisors may include specialists, such as for example, building security experts, medical experts, and/or any other specialists that specialize in responding to different types of emergency situations.

User interest data is displayed on a surveillance station display screen in surveillance mode. In one embodiment, the operations center 104 selects and transmits the selected user interest data to the surveillance station 102 for display at individual surveillance stations 102. In another embodiment, a content distribution center coordinates the organization and transmission of selected user interest data for individual surveillance stations 102. The received user interest data is stored locally at the surveillance station 102. The selected user interest data may depend upon the location of that surveillance station 102 and on the specific requests of the entity authorizing the placement of the surveillance station 102. For example, a surveillance station 102 located in a bank may display user interest data directed to banking needs. Alternatively, if the station is located in a retail space, such as a shopping mall or large store, advertisements of the store(s) and other commercial facilities and their respective goods and services may be displayed on the screen. Stations located in areas frequented by tourists may display historical and local interest information, including displays in several different languages.

The display of user interest data at a surveillance station 102 may unobtrusively and/or attractively draw the attention of people passing by a surveillance station 102 to the location, availability and nature of the surveillance station 102 in a non-emergency environment. This increases the probability that people will recall the location and availability of the surveillance station 102 in the event of an emergency situation.

Further, such unobtrusive attraction may facilitate clearer video surveillance of an individual's appearance in certain embodiments of the present invention. Such information may be useful in the event that subsequent events require identification of individuals present at the location, such as identification of airline passengers or visitors at government or public facilities that may later become sites of emergency situations, or children that become separated from their care-givers.

The surveillance station 102 can be placed in emergency response mode responsive to an emergency signal received from the operations center 104 or responsive to activation of an emergency switch at the surveillance station 102. A two-way real time communication channel is established between the surveillance station 102 and the operations center 104 thereby enabling two way real time audio/video communications between persons at the surveillance station 102 and an operations center advisor.

If a person in the general vicinity of a surveillance station 102 experiences an emergency situation, such as for example, a person experiencing a heart attack, that individual can activate an emergency switch and immediately place that surveillance station 102 in emergency response mode. A real time two way audio/video communication channel is immediately established between the surveillance station 102 and the operations center 104. A real time video of an operations center advisor at the operations 104 appears on the surveillance station display screen and communicates with the person via the surveillance station 102. The operations center advisor evaluates the emergency situation based on real time two way audio/video communication with the person. For example, the operations center advisor may guide the person through medical procedures necessary to assist the person in distress. If necessary, the operations center 104 also notifies local emergency facilities, such as for example, hospitals, police department, and fire department as warranted by the emergency situation.

In the event of an emergency situation that requires implementation of emergency procedures, such as for example, a building evacuation, the operations center 104 places all of the surveillance stations 102 in the area affected by the emergency situation in emergency response mode. An alarm system is activated at each of the surveillance stations 102 that have been placed in emergency response mode to draw attention to that surveillance station 102. A real time two way audio/video communication channel is immediately established between each of the surveillance stations 102 in emergency response mode and the operations center 104. Real time audio/video data continues to be transmitted from the surveillance station 102 to the operations center 104. Real time audio/video data of a live operations center advisor is transmitted from the operations center 104 and displayed on the surveillance station display screen in emergency response mode. The operations center advisor instructs the people in the vicinity of the surveillance station 102 regarding the appropriate emergency safety and/or evacuation procedures. Depending on the nature of the emergency, such information may include oral and/or visual information as to the nearest safe exit or refused or best evacuation route(s) away from the emergency. Different operations center advisors may interface with different surveillance stations 102 and provide location specific instructions.

In one embodiment, the operations center 104 can establish a communications channel between selected surveillance stations 102 and an emergency response center 106 via the operations center 104. The operations center 104 routes real time audio/video of an emergency specialist received from the emergency response center 106 to the appropriate surveillance stations 102. Examples of emergency response centers 106 include but are not limited to, the fire department, the police department, local hospitals and any government agency, such as for example, Homeland Security. National or international agencies may also be connected to the notification system, such as earthquake, weather, flood and Tsunami warning organizations.

One or more surveillance stations 102 are strategically placed throughout a designated area to facilitate security monitoring of the premises or area and to enable operations center advisors to provide effective emergency specific guidance to persons on the premises. The surveillance stations 102 maybe used to monitor areas, such as for example, public and private buildings, indoor stadiums, outdoor stadiums, sports arenas, concert halls, museums and amusement parks, beaches, national monuments and important government or historic sites. The surveillance stations 102 may be, for example, strategically placed throughout a building to monitor building security and provide interactive emergency specific guidance in the event of an emergency situation. For example, operations center advisors may provide building evacuation guidance in the event of a fire in the building. If located out of doors, the advisors may provide maps of appropriate exit or evacuation routes or medical and first aid treatments centers, or to locations or food, water and transportation centers. It should be noted while a number of examples of placement sites for the surveillance stations 102 have been described, the real time emergency response surveillance system 100 can be implemented in any area where emergency response guidance may be necessary to promote individuals safety in the event of an emergency situation.

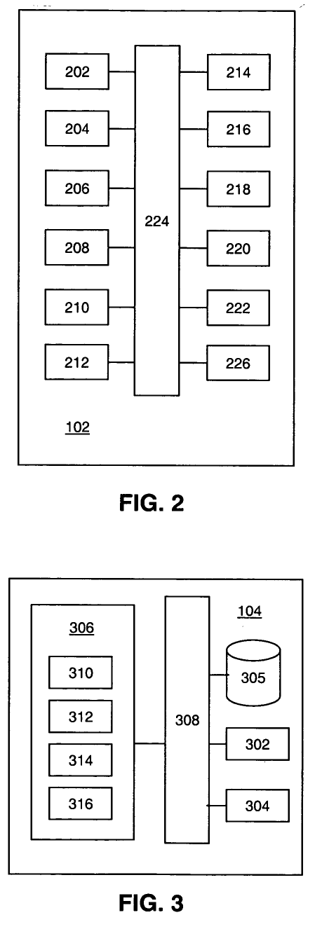

Referring to FIG. 2, a schematic block diagram of another preferred embodiment of a surveillance station 102 in accordance with the principles of the present invention is shown. The surveillance station 102 includes a controller 202 that is communicatively coupled to a local memory 204, a communication module 206, a display screen 208, a video camera 210, a microphone 212, one or more speakers 214, an alarm system 216, an emergency switch 218, a locking mechanism 220, and a door tamper alarm 222 via a network 224. In one embodiment, the surveillance station 102 includes a global positioning (GPS) unit 226.

In one embodiment, the controller 202 is a digital signal processor (DSP). In another embodiment the processor may be implemented as a microcontroller, microprocessor, controller, host processor, or communications processor. The processor may be implemented as an application specific integrated circuit (ASIC). In another embodiment, the processor may be implemented as a processor working in conjunction with a central processing unit (CPU) performing the function of a general purpose processor. The processor executes various computer programs that control programming and operational modes of electronic and mechanical systems within the surveillance station 102, and communications via the communication module 206.

The communication module 206 includes a transmitter and a receiver. The transmitter transmits the real time video data recorded by the video camera 210 and the real time audio data picked up by the microphone 212 from the surveillance station 102 to the operations center 104. The receiver receives communication data from the operations center 104 including real time audio/video data of the operations center advisor. The received video data is displayed in real time on the display screen 208 and the received audio data is transmitted in real time via the speakers 214.

In one embodiment the display screen 208 is a cathode ray tube (CRT) display. In another embodiment, the display screen 208 is a liquid crystal (LCD) display. While a number of types of display screens 208 have been described other types of display screens 208 are also considered to be within the scope of the invention. The display screen 208 may be communicatively coupled to the controller 202 via a wired or wireless communication network.

The video camera 210 is strategically positioned to achieve site specific surveillance objectives. In one embodiment, the video camera 210 is positioned on a rotating base to provide maximum coverage of the area under surveillance. In another embodiment, the operations center advisor can remotely control the position of the video camera 210. In another embodiment, the video camera 210 is located remotely from the surveillance station 102 and is communicatively coupled to the controller 202 and the communication module 206 via a wired or wireless communication network.

The alarm system 216 is activated when the surveillance station 102 is placed in emergency response mode. The controller 202 coordinates the activation of the alarm system 216. In one embodiment, the alarm system 216 includes a siren. In another embodiment, the alarm system 216 includes a strobe light. In another embodiment, the alarm system 216 consists of a combination of a siren and a strobe light. In a preferred embodiment, the alarm system 216 includes a siren, a red strobe light and a blue strobe light.

In one embodiment, the controller 202 activates the blue strobe light when the surveillance station 102 receives a notification message. In one embodiment, the blue strobe light is activated for a pre-defined period of time following the receipt of the notification message from the operations center 104. In one embodiment, the pre-defined period of time is approximately ten seconds.

In a preferred embodiment, the controller 202 activates the red strobe light and the siren when the surveillance station 102 is placed in emergency response mode responsive to activation of the emergency switch 218. The alarm system 216 remains activated until the surveillance station 102 is reset by the operations center 104. The operations center 104 resets the surveillance station 102 once the operations center determines that the emergency situation has been resolved or abated.

In a preferred embodiment, the controller 202 activates the red strobe light, the blue strobe light and the siren when the operations center 104 places the surveillance station 102 in emergency response mode. The alarm system 216 remains activated until the surveillance station 102 is reset by the operations center 104. The operations center 104 resets the surveillance station 102 once the operations center determines that the emergency situation has been resolved or abated. It should be noted that while a number of different alarm systems 216 have been described, other types of alarm systems 216 are also considered to be within the scope of the invention.

In one embodiment, the emergency switch 218 consists of a push button. In another embodiment, the emergency switch 218 consists of a lighted push button. In another embodiment, the emergency switch 218 consists of a lighted red push button. While a number of types of emergency switches 218 have been described, it should be noted that the use of other colors and forms of emergency switches 218 are also considered to be within the scope of the invention. The controller 202 places the surveillance station 102 in emergency response mode responsive to activation of the emergency switch 218.

In one embodiment, the surveillance station 102 includes a back up power supply (not shown). The back up power supply is activated responsive to a failure of the primary power supply powering the surveillance station 102. In one embodiment, the back up power supply has the capacity to power the surveillance station 102 for approximately an hour.

Referring to FIG. 3, a schematic block diagram of a preferred embodiment of an operations center 104 in accordance with the principles of the present invention is shown. The operations center 104 includes a operations controller 302, one or more communication modules 304, one or more operations databases 305, and one or more operations center advisor stations 306 communicatively coupled via a network system 308. Each operations center advisor station 306 is equipped with a video camera 310, a display screen 312, a microphone 314 and one or more speakers 316.

In one embodiment, the operations controller 302 is a digital signal processor (DSP). In another embodiment the processor may be implemented as a microcontroller, microprocessor, controller, host processor, or communications processor. The processor may be implemented as an application specific integrated circuit (ASIC). In another embodiment, the processor may be implemented as a processor working in conjunction with a central processing unit (CPU) performing the function of a general purpose processor. The processor executes various computer programs that control programming and operational modes of electronic and mechanical systems within the operations center 104 and manages the flow of audio/video into and out of the operations center 104.

The communication module 304 includes a transmitter and a receiver. The transmitter transmits the real time video data recorded by the video camera 310 and the real time audio data picked up by the microphone 314 from operations center advisors station to the surveillance station 102. The receiver receives the real time audio/video data from the surveillance stations 102. The operations controller 302 routes the received audio/video data to the appropriate operations center advisors station 306 for display on the display screen 312 and for transmission via the speakers 316.

All of the real time audio/video data received at the operations center 104 from the one or more surveillance stations 102 and all of the real time audio/video data transmitted from the operations center 104 to a surveillance station 102 is stored in the operations database 305.

In one embodiment the display screen 312 is a cathode ray tube (CRT) display. In another embodiment, the display screen 312 is a liquid crystal (LCD) display. While a number of types of display screens 312 have been described other types of display screens 312 are also considered to be within the scope of the invention. The display screen 312 may be communicatively coupled to the operations controller 302 via a wired or wireless communication network.

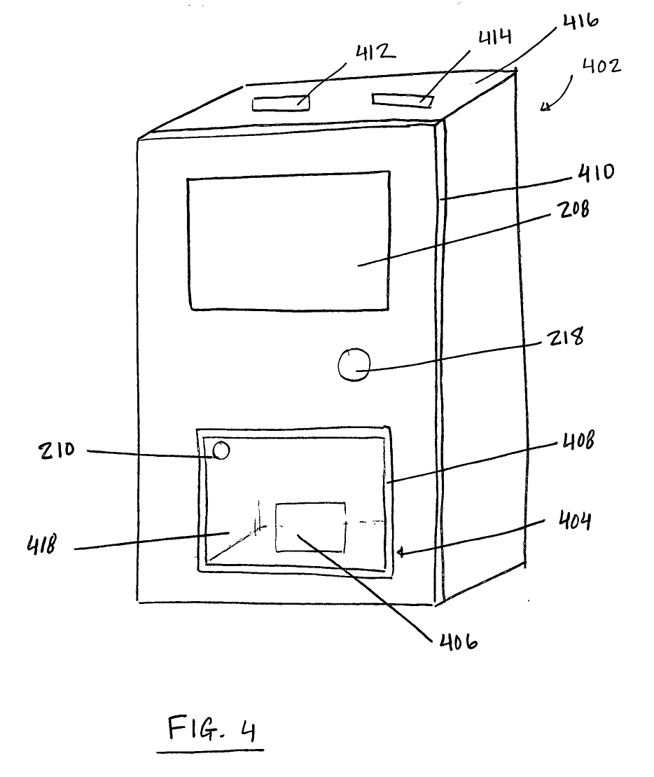

FIG. 4 shows another preferred embodiment of a surveillance station 102 in accordance with the principles of the present invention is shown. Referring to FIG. 2 and

FIG. 4, the surveillance station 102 is integrated into a cabinet 402. The cabinet 402 includes two separate compartments an upper compartment and a lower compartment 404. The lower compartment 404 used to store medical or emergency supplies or equipment such as medical device 406. The medical device 406 can be accessed by opening a compartment door 408. The compartment door 408 is locked using the 220. The locking mechanism 220 is controlled by the controller 202 and is maintained in a default locked position.

In the event of an emergency situation, the locking mechanism 220 is unlocked responsive to a release signal received from the operations center 104 thereby permitting a user to access the medical device 406. In one embodiment, the locking mechanism 220 is a servo driven locking mechanism 220. In one embodiment, the locking mechanism 220 is unlocked responsive to a disruption in power supplied to the surveillance station 102. In another embodiment, the locking mechanism 220 is released after a pre-defined period of time following a failure to establish a two-way real time communication channel between the surveillance station 102 and the operations center 104 upon activation of the emergency switch 218. In one embodiment, the pre-defined period of time is approximately 10 seconds. In one embodiment, the medical device compartment 404 includes a door tamper alarm 222 that is activated if the compartment door 412 is forced open. In one embodiment, the door tamper alarm 222 consists of a siren.

The cabinet 402 including a cabinet door 410. The cabinet door 410 provides access to both the upper compartment and the medical device compartment 404. The surveillance station circuitry, including, the controller 202, local memory 204, and the communication module 206 are disposed within the upper compartment behind the display screen 208.

The display screen 208 is held in place within an opening in the upper section of the cabinet door 410. The emergency switch 218 is a red lighted push button and is affixed to the cabinet door 410 below the display screen 208. The alarm system 216 includes a red strobe light 412, a blue strobe light 414 and a siren. The red strobe light 412 and the blue strobe light 414 are disposed on an upper surface 416 of the cabinet 402.

As mentioned previously, the lower compartment is the emergency storage compartment 404. In a preferred embodiment, compartment door 408 includes a transparent window 418. In one such embodiment, the transparent window 418 is a Plexiglas window. The medical device 406 is stored within the medical device compartment 404 and is visible through the transparent window 418. In one preferred embodiment, the medical device 406 consists of a stand alone portable automatic defibrillator device. In one embodiment, the video camera 210 is disposed within the medical device compartment 404 behind the transparent window 418. In another embodiment, the video camera 210 is strategically positioned in a location outside of the cabinet 402 to optimize surveillance of the area. The video camera 210 may be communicatively coupled to the controller 202 and communications module 206 via a wired or wireless communication network.

Although one preferred embodiment includes medical cabinet 404, it should be understood that cabinet 402 may include additional compartments to store other emergency or medical equipment and supplies, such as first aid kits, respirators, flashlights, protective gloves land the like. Optionally, cabinet 402 may include compartment(s) for non-medical equipment that replace medical compartment 404.

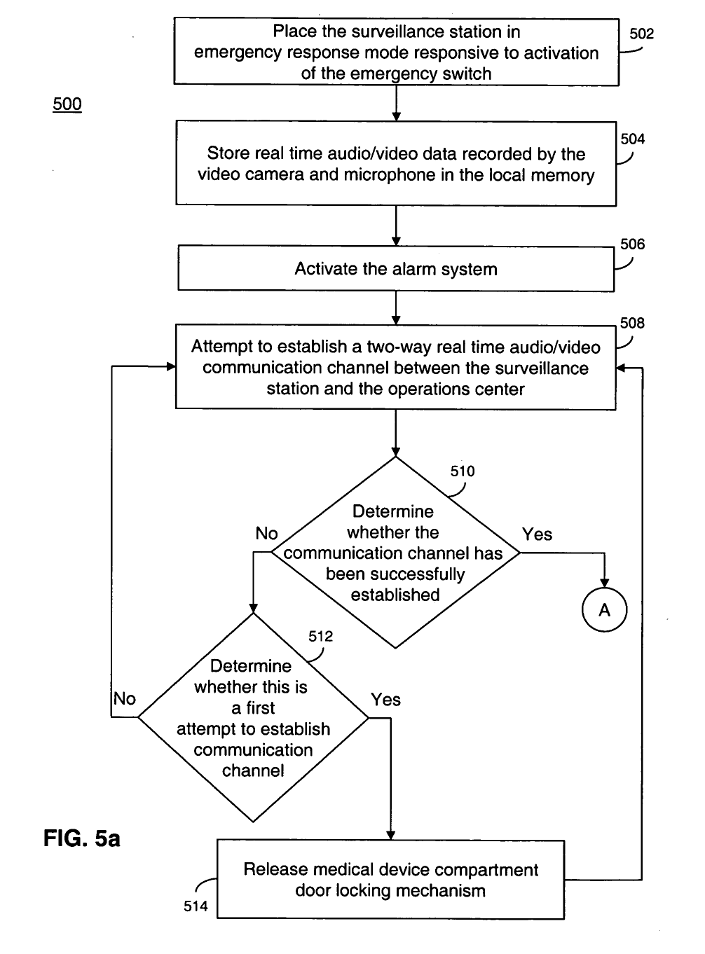

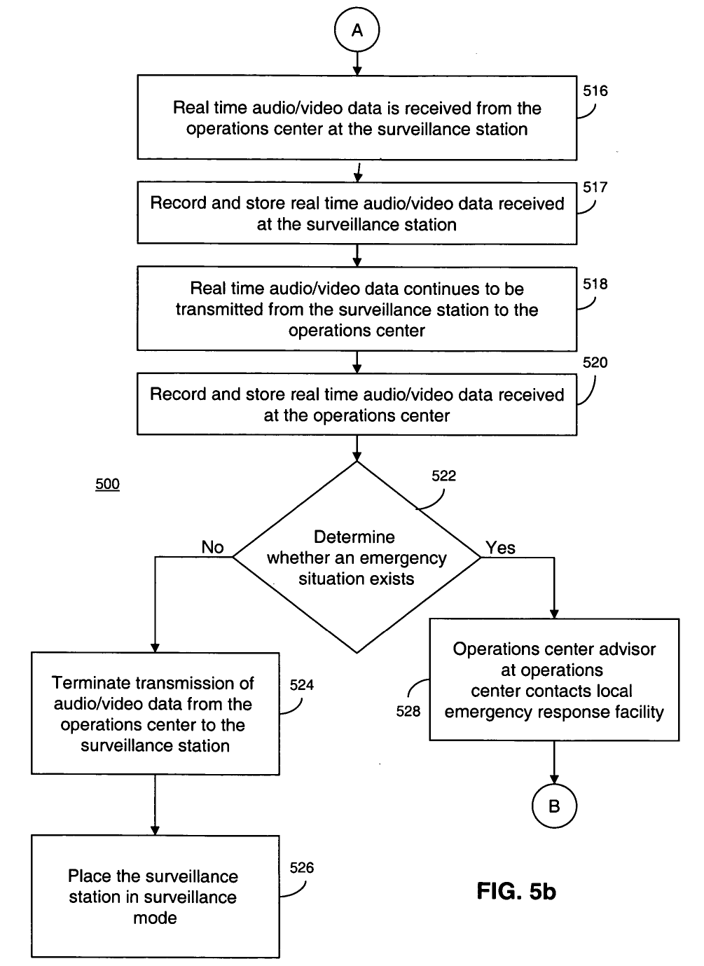

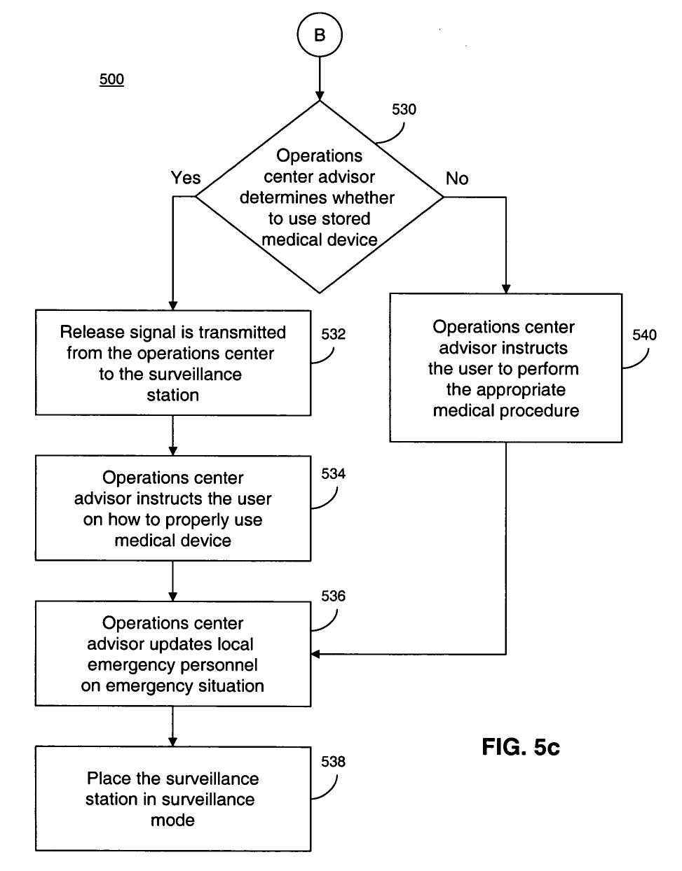

Referring to FIG. 5a-c, a flowchart of one embodiment of a method of operating the surveillance station that has been placed in emergency response mode 500 responsive to activation of the emergency switch 218 in accordance with the principles of the present invention is shown. The method 500 begins at 502 with the controller 202 placing the surveillance station 102 in emergency response mode responsive to detecting that the emergency switch 218 has been activated.

At step 504, the real time audio/video data captured by the microphone 212 and the video camera 210 is stored in the local memory 204. In this manner, the surveillance station 102 maintains an audio/video record of the emergency situation.

The controller 202 activates the alarm system 216 at step 506. The alarm system 216 is activated responsive to activation of the emergency switch 218. In one embodiment, the alarm system 216 consists of a red strobe light 412 and a siren. In one embodiment, the red strobe light 412 and the siren are activated for a predetermined period of time. In one embodiment, the predetermined period of time is approximately ten seconds. It should be noted that while a preferred alarm system 216 has been described, other types of alarm systems 216 are also considered to be within the scope of the invention.

The controller 202 attempts to establish a two way real time audio/video communication channel between the surveillance station 102 and the operations center 104 at step 508. The surveillance system 102 is already transmitting real time audio/video data to the operations center 104. Establishing a real time two-way audio/video communication channel between the surveillance station 102 and the operations center 104 involves establishing a real time communication channel from operations center 104 to the surveillance station 102 thereby enabling the operations center 104 to transmit real time audio/video data from the operations center 104 to the surveillance station 102.

The controller 202 determines whether the two-way real time audio/video communication channel was successfully established at step 510. If the controller 202 is unable to establish the two-way real time communication channel between the surveillance system 102 and the operations center 104 within a predetermined period of time, the controller 202 determines whether this is the first attempt to establish the communication link at step 512.

If the controller 202 determines that this was the first attempt to establish a two-way real time communication channel between the surveillance station 102 and the operations center 104 at step 512, the controller 202 waits for a predetermined period of time and then unlocks the medical device compartment door locking mechanism 220 at step 514 and the user is provided with access to the medical device 406. The controller 202 continues attempts to establish a two-way real time communication channel between the surveillance station 102 and the operations center 104 as indicated in step 508. If the controller 202 determines that this was not a first attempt to establish a two-way real time communication channel between the surveillance station 102 and the operations center 104 at step 512, the controller 202 returns to step 508 and repeats attempts to establish the two-way real time communication channel. If the controller 202 determines that the two-way real time communication channel has been successfully established between the surveillance station 102 and the operations center 104 at step 510, the method proceeds to step 516. If warranted, the operation center may cause a full screen or partial screen interactive display of data during the emergency mode, permitting the user to input selections without the need for oral communications in a manner similar to that used to access, display and interact with the interactive data in the non-emergency mode.

At step 516, real time audio/video data of alive operations center advisor is received from the operations center 104 at the surveillance station 102. The real time live audio/video data is picked up by the microphone 314 and the video camera 310 located at the operations center advisor station 306. The real time audio/video data received from the operations center 104 is stored in a local memory at step 517. The real time video data is displayed on the display screen 208 and the real time audio data is transmitted via the speakers 214. The user at the surveillance station 102 can hear and see the operations center advisor at the operations center 104 via the display screen 208 and the speakers 214 on a real time basis.

The controller 202 continues to transmit real time audio/video data from the surveillance station 102 to the operations center 104 at step 518. The real time live audio/video data is picked up by the microphone 212 and the video camera 210 located at the surveillance station 102.

The real time video data received from the surveillance station 102 at the operations center 104 is displayed on the display screen 312 and the received real time audio data is transmitted via the speakers 316. The operations center advisor can hear and see the user and the patient on a real time basis. The audio/video data received from the surveillance station 102 and the audio/video data transmitted from the operations center to the surveillance station are stored in the operations center database 305 at step 520.

The two-way real time audio/video communication link permits the operations center advisor at an operations center 104 to communicate directly with a user located at the surveillance station 102. This permits the operations center advisor to evaluate the emergency situation at the surveillance station 102 to determine whether an emergency situation exists at step 522.

If the operations center advisor determines that the situation at the surveillance station 102 is not an emergency situation based on two way real time audio/video data exchanged between the surveillance station 102 and operations center 104, the operations center advisor authorizes the transmission of the emergency resolved signal from the operations center 104 to the surveillance station 102. The controller 202 continues to transmit real time audio/video surveillance data from the surveillance station 102 to the operations center 104. The operations center 104 terminates the transmission of real time audio/video data from the operations center 104 to the surveillance station 102 at step 524. The controller 202 places the surveillance station in surveillance mode 102 responsive to the emergency resolved signal at step 526. The controller 202 resumes display of the user interest data on the display screen 208.

If the operations center advisor determines that the situation at the surveillance station 102 is indeed an emergency situation based on two way real time audio/video communication with the user and/or person in distress at step 522, the operations center advisor contacts a local emergency response facility at step 528. Such local emergency response facilities may include, but are not limited to, a fire department, a police department, and a local hospital.

In one embodiment, the surveillance station location data is stored in the local memory 204. The operations center advisor retrieves the location data from the surveillance station 102 and informs the local emergency response facility of the location of the emergency situation. In another embodiment, the surveillance station 102 includes a GPS unit 226. The operations center advisor obtains the surveillance station location data from the GPS unit 226.

At step 530, the operations center advisor determines whether use of the medical device 406 stored in the locked compartment 404 is necessary to treat the person in distress. The operations center advisor makes this determination based on two-way real time audio/video communication with the user at the surveillance station 102 and/or the person in distress. For example, the operations center advisor may ask the user questions and to provide information regarding the physical condition of the person in distress. If for example, the operations center advisor determines that the person in distress is experiencing sudden cardiac arrest and the stored medical device 406 is a portable AED, the operations center advisor may determine that the use of the AED is necessary to save the distressed person's life.

If the operations center advisor determines that use of the stored medical device 406 is warranted, the operations center advisor directs the transmission of a release signal from the operations center 104 to the surveillance station 102 at step 532. The controller 202 unlocks the locking mechanism 220 responsive to the received release signal. In one embodiment, the locking mechanism 220 is a servo driven locking mechanism 220. The controller 202 issues the appropriate commands to drive the servo to unlock the medical device compartment door 408. Once the locking mechanism 220 is unlocked, the user can retrieve the medical device 406 stored in the medical device compartment 404. The operations center advisor instructs the user on the proper use of the medical device 406 via real time two-way audio/video communication link at step 534.

The operations center advisor continues to guide the user with assisting the person in distress until the local emergency personnel arrive at the location of the emergency situation. At step 536, the operations center advisor updates the local emergency personnel on the status of the emergency situation. The operations center advisor may update the local emergency personnel of the patient's medical condition, a description of one or more medical treatments and the patient's response to the medical treatments.

Once the local emergency personnel have gained control over the emergency situation, the operations center advisor authorizes the operations center 104 to transmit the emergency resolved signal to the surveillance station 102. The controller 202 responds to the received emergency resolved signal by placing the surveillance station 102 in surveillance mode at step 538. The controller 202 resumes display of the user interest data on the display screen 208.

If the operations center advisor determines that use of the stored medical device 406 is not warranted at step 530, the operations center advisor does not authorize the transmission of a release signal from the operations center 104 and compartment 404 remains locked. At step 540, the operations center advisor remains on the two way real time audio/video communication channel to guide the user through the appropriate medical procedures to assist the person in distress. For example, if the person in distress is bleeding, the operations center advisor may guide the user through use of pressure bandages. The operations center advisor remains in two way real time audio/video communication with the user until personnel from the local emergency response facility arrive at the scene of the emergency. The method proceeds to step 536 where the operations center advisor updates the local emergency personnel on the status of the emergency situation. The operations center advisor may update the local emergency personnel of the patient's medical condition, a description of one or more medical treatments and the patient's response to the medical treatments. In this manner, control can be maintained over the treatment being supplied to the patient while preventing unnecessary use and/or potential loss of expensive stored medical or emergency equipment or supplies.

Once the local emergency personnel have gained control over the emergency situation, the operations center advisor authorizes the operations center 104 to transmit the emergency resolved signal to the surveillance station 102. The controller 202 responds to the received emergency resolved signal by placing the surveillance station 102 in surveillance mode at step 538. The controller 202 resumes display of the user interest data on the display screen 208.

While a particular sequence of steps have been described above, it should be noted that a method 500 having substantially similar steps or steps in a different sequence are also considered to be within the scope of the invention.

In the event of an emergency situation requiring the implementation of emergency procedures, such as for example, a building evacuation, the operations center 104 issues an emergency signal to all of the surveillance stations 104 in the area affected by the emergency situation. The controller 202 places the surveillance station 102 in emergency response mode responsive to the received emergency signal. A real time audio/video communication channel is established between the surveillance station 102 and the operations center 104 to enable the transmission of audio/video data from the operations center 104 to the surveillance station 102 thereby creating a two way real time audio/video communication channel between the surveillance station 102 and the operations center 104. An operations center advisor at the operations center 104 can assess the impact of the emergency situation in the vicinity of the surveillance station 102 based on the real time audio/video data received from the surveillance station 102. The operations center advisor provides live audio/video emergency response guidance to the people in the area. Based on a review of the audio/video data feedback received from the surveillance station 102 location, the emergency response guidance can be responsively modified to adjust to potentially changing circumstances at the location of the surveillance station 102.

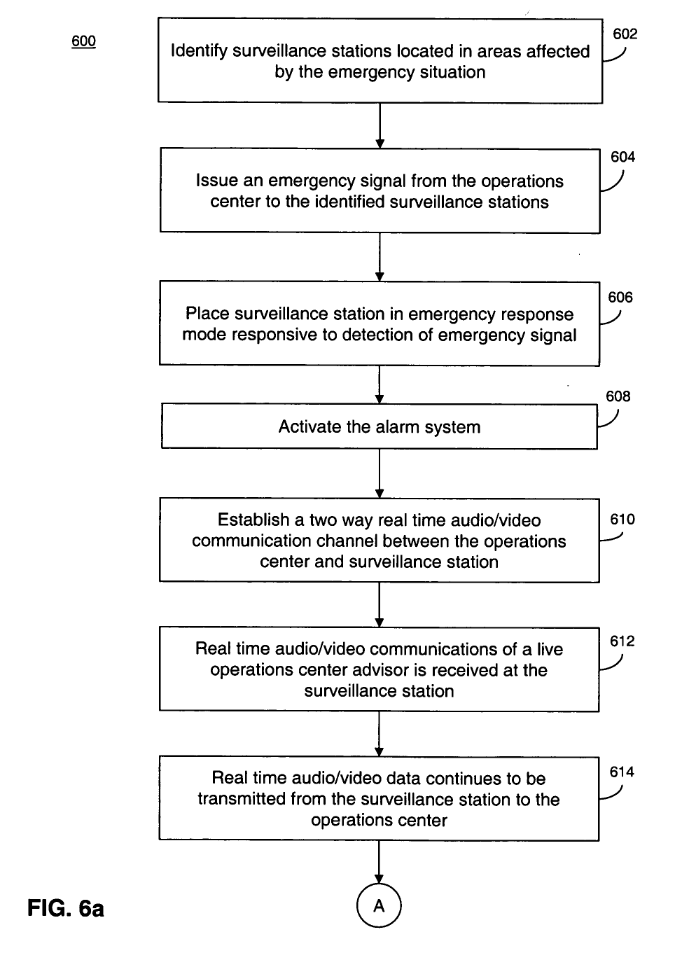

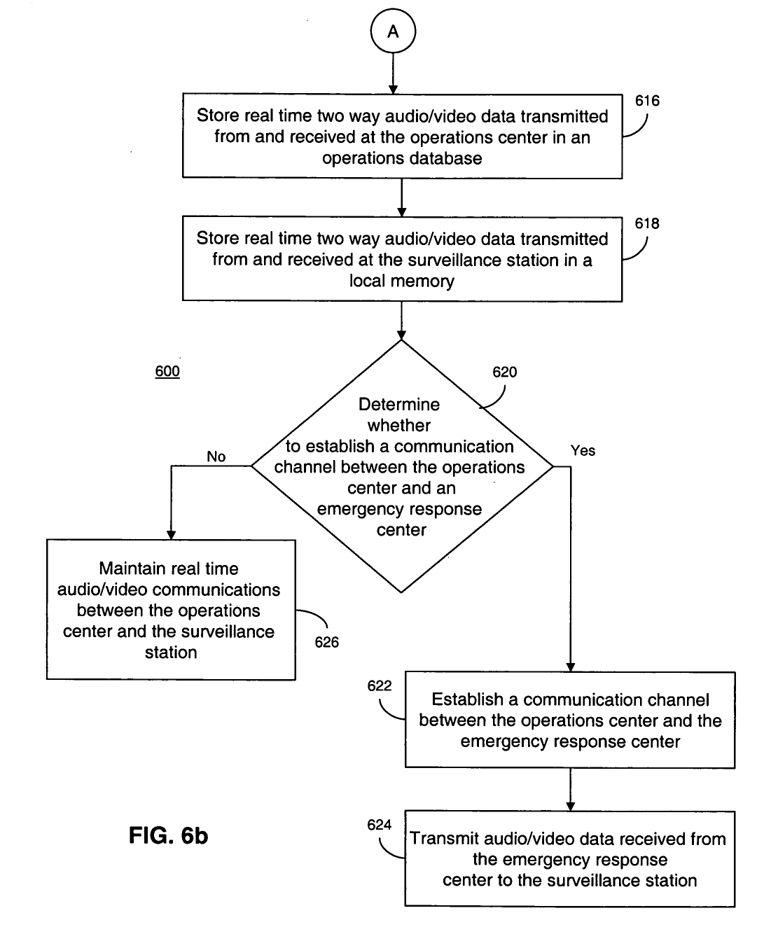

Referring to FIG. 6a-b, a flowchart of one embodiment of a method of operating the surveillance station 102 that has been placed in emergency response mode responsive to an emergency signal received from the operations center 600 in accordance with the principles of the present invention is shown. In the event of an emergency situation, the method 600 begins at step 602 with the operations center 104 identifying the surveillance stations 102 located in the areas affected by the emergency situation. An emergency signal is issued to each of the identified surveillance stations 102 at step 604. When the controller 202 at each of the identified surveillance stations 102 detects the emergency signal, the controller 202 responsively places the surveillance station 102 in emergency response mode at step 606 and activates the alarm system 216 at step 608. In one embodiment, the alarm system 216 consists of a red strobe light 412, a blue strobe light 414, and a siren. In one embodiment, the alarm system 216 remains activated until the surveillance station 102 is returned to surveillance mode. While one example of an emergency response alarm system 216 has been described, alternative types of alarm systems are also considered to be within the scope of the invention.

At step 610, a real time audio/video communication channel is established between the surveillance station 102 and the operations center 104 to enable the transmission of real time audio/video data from the operations center 104 to the surveillance station 102 thereby creating a two way real time audio/video communication channel between the surveillance station 102 and the operations center 104. At step 612, the live real time audio/video data of the operations center advisor received from the operations center 104 at the surveillance station 102 is displayed on the display screen 208 and transmitted via the speakers 214. This permits the people at the surveillance station 102 to hear and see the operations center advisor at the operations center 104 via the display screen 208 and the speakers 214 on a real time basis.

At step 614, live real time audio/video data picked up by the video camera 210 and the microphone 212 continue to be transmitted from the surveillance station 102 to the operations center 104. The real time audio/video data received at the operations center 104 is routed to an operations advisor station 306 and displayed on the display screen 312 and transmitted via the speakers 316. The operations center advisor at the operations center 104 can hear and see the people in the vicinity of the surveillance station 102 on a real time basis.

The real time two-way audio/video communication link permits the operations center advisor at an operations center 104 to communicate directly with the people in the vicinity of the surveillance station 102. This permits the operations center advisor to evaluate the emergency situation at the surveillance station 102 and provide the people in the vicinity of the surveillance station 102 with the appropriate guidance based on the received feedback.

At step 616 the real time audio/video data transmitted from and received at the operations center 104 is stored in the operations database 305 and at step 618, the real time audio/video data transmitted from and received at the surveillance station 102 is stored in the local memory 204. This preserves a record of all communications between the operations center 104 and surveillance stations 102 for future assessment and review.

At step 620, the operations center advisor at the operations center 104 determines whether to establish a communication channel between the operations center 104 and an emergency response center 106. In the event of a widespread emergency situation, such as for example, an earthquake, a hurricane, a tornado or a terrorist attack, emergency response agencies, such as for example The Department of Homeland Security, may take a more active role in informing and guiding people to safety. If the operations center 104 determines that an emergency response center 106 may be better equipped to guide people to safety, the operations center advisor establishes a communication channel between the operations center 104 and the appropriate emergency response center 106 at step 622 such that the operations center 104 is able to receive real time audio/video transmissions from the emergency response center 106.

At step 624, the audio/video transmissions received from the emergency response center 106 at the operations center 104 are transmitted from the operations center 104 to the surveillance stations 102. The controller 202 displays the received audio/video data on the display screen 208 and transmits the audio via the speakers 214. Thus people in the vicinity of the surveillance station 102 are provided with the latest status of the emergency situation as well as guidelines for dealing with the emergency situation.

If the operations center advisor determines that it is unnecessary to establish a communication channel between the operations center 104 and an emergency response center 106, real time two way audio/video communications are maintained between the operations center 104 and the surveillance station 102 and the operations center advisor continues to provide emergency situation specific guidance to the people in the vicinity of the surveillance station at step 626.

While a particular sequence of steps have been described above, it should be noted that a method 600 having substantially similar steps or steps in a different sequence are also considered to be within the scope of the invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A surveillance station comprising:
a controller operable to place the surveillance station in one of a surveillance mode and an emergency response mode;
a video camera communicatively coupled to the controller;
a communication module communicatively coupled to the controller, the communication module being operable to transmit real time video data from the video camera to an operations center in both the surveillance mode and the emergency response mode and to receive real time video data from the operations center in the emergency response mode;
a display screen communicatively coupled to the controller, the display screen being operable to display the real time video data received from the operations center; and
an emergency switch communicatively coupled to the controller wherein the controller is operable to place the surveillance station in the emergency response mode responsive to activation of the emergency switch.

2. The surveillance station of claim 1, wherein the controller is operable to place the surveillance station in emergency response mode responsive to an emergency signal received from the operations center.

3. The surveillance station of claim 1, wherein the controller is operable to place the surveillance station in the surveillance mode as a default mode.

4. The surveillance station of claim 1, further comprising an alarm system communicatively coupled to the controller, wherein the controller is operable to activate the alarm system responsive to activation of the emergency switch.

5. The surveillance station of claim 1, further comprising an emergency storage compartment with a locking mechanism communicatively coupled to the controller, the locking mechanism being operable to unlock the compartment responsive to a release signal received from the operations center, the emergency storage compartment being able to store medical or emergency supplies or equipment.

6. The surveillance station of claim 5, wherein the locking mechanism is released after a predefined period of time if the controller is unable to establish a real time two-way communication link between the surveillance station and the operations center in emergency response mode.

7. The surveillance station of claim 5, wherein the locking mechanism is released responsive to a disruption of power supplied to the surveillance station.

8. The surveillance station of claim 5, wherein the locking mechanism comprises a servo driven locking mechanism.

9. The surveillance station of claim 5, further comprising an automatic external defibrillator stored in the emergency storage compartment.

10. The surveillance station of claim 1, wherein the real time video data received from the operations center comprises real time video data of an operations center advisor.

11. The surveillance station of claim 1, further comprising a local memory communicatively coupled to the controller, wherein the local memory is operable to store the real time video data transmitted from the surveillance station to the operations center and the real time video data received from the operations center at the surveillance station when the surveillance station is in the emergency response mode.

12. The surveillance station of claim 1, further comprising:
a microphone communicatively coupled to the communication module, wherein the communication module is operable to transmit real time audio data received at the microphone to the operations center; and
a speaker communicatively coupled to the communication module, wherein the speaker is operable to transmit the real time audio data received from the operations center at the surveillance station.

13. The surveillance station of claim 12, further comprising a local memory communicatively coupled to the controller, wherein the local memory is operable to store the real time audio data transmitted from the surveillance station to the operations center and the real time audio data received from the operations center at the surveillance station when the surveillance station is in the emergency response mode.

14. The surveillance station of claim 1, further including a back up power source operable to power the surveillance station responsive to a failure of a primary power source.

15. The surveillance station of claim 1 wherein the communications module transmits the real time video data to the operations center and receives real time video data from the operations center from via a communication system wherein the communication system is selected from the group consisting of a satellite communication system, a T1 line system, a T3 line system, an OC3 fiber system, an OC12 fiber system an OC48 fiber system, an OC192 fiber system, and a DSL system.

16. A method of responding to an emergency situation using a surveillance station, the method comprising:
placing a surveillance station in one of a surveillance mode and an emergency response mode;
transmitting real time video data from the surveillance station to an operations center in both the surveillance mode and the emergency response mode;
receiving real time video data from the operations center at the surveillance station in the emergency response mode;
displaying the real time video data received from the operations center on a display screen at the surveillance station; and
placing the surveillance station in emergency response mode responsive to activation of an emergency switch.

17. The method of claim 16, further comprising placing the surveillance station in the emergency response mode responsive to an emergency signal received from the operations center.

18. The method of claim 16, further comprising placing the surveillance station in the surveillance mode as a default mode.

19. The method of claim 16, further comprising activating an alarm system responsive to activation of the emergency switch.

20. The method of claim 16, further comprising providing a medical device compartment with a locking mechanism in the surveillance station.

21. The method of claim 20, further comprising releasing the locking mechanism responsive to a release signal received from the operations center at the surveillance station in emergency response mode.

22. The method of claim 20, further comprising releasing the locking mechanism after a predefined period of time following a failure to establish a real time two-way video communication link between the surveillance station and the operations center in emergency response mode.

23. The method of claim 20, further comprising releasing the locking mechanism responsive to a disruption of power supplied to the surveillance station.

24. The method of claim 20, further comprising storing a standalone automatic external defibrillator unit in the medical device compartment.

25. The method of claim 16, wherein the real time video data received from the operations center comprises real time video data of an operations center advisor.

26. The method of claim 16, further comprising storing the real time video data transmitted from the surveillance station to the operations center and the real time video data received at the surveillance station from the operations center in a local memory at the surveillance station.

27. The method of claim 16, further comprising storing the real time video data received from the surveillance station at the operations center and the real time video transmitted from the operations center to the surveillance station in an operations center database.

28. The method of claim 16, further comprising:
transmitting real time audio data from the surveillance station to the operations center; and
receiving real time audio data from the operations center at the surveillance station in the emergency response mode.

29. The method of claim 28, further comprising storing the real time audio data transmitted from the surveillance station to the operations center and the real time audio data received from the operations center at the surveillance station in a local memory when the surveillance station is in emergency response mode.

30. The method of claim 28, further comprising storing the real time audio data transmitted from the operations center to the surveillance station and the real time audio data received from the surveillance station at the operations center in an operations database.

31. The method of claim 16, further comprising activating a back up power source operable to power the surveillance station responsive to a failure of a primary power source.

32. A computer readable medium storing a computer program for responding to an emergency situation using a surveillance station, comprising:
computer readable code for placing a surveillance station in one of a surveillance mode and an emergency response mode;
computer readable code for transmitting real time video data from the surveillance station to an operations center in both the surveillance mode and the emergency response mode;
computer readable code for receiving real time video data from the operations center at the surveillance station in emergency response mode;
computer readable code for displaying the real time video data received from the operations center on a display screen in emergency response mode; and
computer readable code for placing the surveillance station in the emergency response mode responsive to activation of an emergency switch

33. The computer readable medium of claim 32, further comprising computer readable code for placing the surveillance station in emergency response mode responsive to an emergency signal received from the operations center.

34. The computer readable medium of claim 32, further comprising computer readable code for placing the surveillance station in surveillance mode as a default mode.

35. The computer readable medium of claim 32, further comprising computer readable code for activating an alarm system responsive to activation of the emergency switch.

36. The computer readable medium of claim 32, further comprising computer readable code for issuing an unlock signal to release a locking mechanism of an emergency storage compartment responsive to a release signal received from the operations center.

37. The computer readable medium of claim 36, further comprising computer readable code for issuing the unlock signal after a predefined period of time following a failure to establish a real time two-way video communication link between the surveillance station and the operations center when the surveillance station is in emergency response mode.

38. The computer readable medium of claim 36 further comprising computer readable code for issuing the unlock signal responsive to a disruption of power supplied to the surveillance station.

39. The computer readable medium of claim 32, further comprising computer readable code for storing the real time video data recorded at the surveillance station and the real time video data received at the surveillance station from the operations center in the emergency response mode in a local memory.

40. The computer readable medium of claim 32, further comprising computer readable code for storing the real time video data received from the surveillance station at the operations center and the real time video transmitted from the operations center to the surveillance station in an operations center database.

41. The computer readable medium of claim 32, further comprising:
computer readable code for transmitting real time audio data from the surveillance station to the operations center; and
computer readable code for receiving real time audio data from the operations center at the surveillance station in emergency response mode.

42. The computer readable medium of claim 41, further comprising:
computer readable code for storing the real time audio data transmitted from the surveillance station during emergency response mode in a local memory; and
computer readable code for storing the real time audio data received at the surveillance station in the local memory in emergency response mode.

43. The computer readable medium of claim 41, further comprising:
computer readable code for storing the real time audio data received from the surveillance station in an operations center database when the surveillance station is in emergency response mode; and
computer readable code for storing the real time audio transmitted to the surveillance station in the operations center database in emergency response mode.

44. The computer readable medium of claim 32, further comprising computer readable code for activating a back up power source operable to power the surveillance station responsive to a failure of a primary power source.

45. A real time emergency response surveillance system, the system comprising:
a plurality of surveillance stations, each of the plurality of surveillance stations having an emergency switch and being operable to be individually placed in one of an emergency response mode and a surveillance mode, wherein each of the surveillance stations is operable to be individually placed in the emergency response mode responsive to activation of the emergency switch; and
an operations center communicatively coupled to the plurality of surveillance stations, wherein a first of the plurality of surveillance stations is operable to transmit real time video data from the first surveillance station to the operations center in both the surveillance mode and the emergency response mode, and wherein the first surveillance station is operable to receive real time video data from the operations center in emergency response mode.

46. The real time emergency response system of claim 45, wherein each of the plurality of surveillance stations is operable to be individually and selectively placed in emergency response mode responsive to an emergency signal received from the operations center.

47. The real time emergency response system of claim 45, wherein the first surveillance station is operable to transmit real time audio data to an operations center and receive real time audio data from the operations center at the first surveillance station in the emergency response mode.
